(19) United States
(12) Patent Application Publication
(10) Pub. No.: US 2004/0007676 A1
(43) Pub. Date: Jan. 15, 2004

(54) Radiation image storage panel

(75) Inventors: Yasuo Iwabuchi, Kaisei-machi (JP); Hiroshi Matsumoto, Kaisei-machi (JP); Yuichi Hosoi, Kaisei-machi (JP); Makoto Kashiwaya, Kaisei-machi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/394,577

(22) Filed: Mar. 24, 2003

(30) Foreign Application Priority Data
Mar. 25, 2002 (JP) (PAT. 083745/2002
Dec. 27, 2002 (JP) (PAT. 380243/2002

(51) Int. Cl. G03B 42/08

(52) U.S. Cl. 250/484.4

(57) ABSTRACT

A radiation image storage panel comprises a substrate and a stimulable phosphor layer overlaid on the substrate. The substrate has a plurality of protruding regions over an entire surface of the substrate. The stimulable phosphor layer comprises a plurality of pillar-shaped structures of a stimulable phosphor, which pillar-shaped structures extend in a layer thickness direction of the stimulable phosphor layer, each of the pillar-shaped structures of the stimulable phosphor having been formed with one of the protruding regions of the substrate as a starting point of the pillar-shaped structure and with a vapor phase deposition technique. A surface of the stimulable phosphor layer is formed with only the pillar-shaped structures of the stimulable phosphor, which pillar-shaped structures extend respectively from the protruding regions of the substrate.

### BACKGROUND OF THE INVENTION

1. Field of the Invention

This invention relates to a radiation image storage panel for use in radiation image recording and reproducing techniques, in which stimulable phosphors are utilized. This invention particularly relates to a radiation image storage panel, which comprises a stimulable phosphor layer having been formed with a vapor phase deposition technique.

2. Description of the Related Art

In lieu of conventional radiography, radiation image recording and reproducing techniques utilizing stimulable phosphors have heretofore been used in practice. The radiation image recording and reproducing techniques are described in, for example, U.S. Pat. No. 4,239,968. The radiation image recording and reproducing techniques utilize a radiation image storage panel (referred to also as the stimulable phosphor sheet) provided with a stimulable phosphor. With the radiation image recording and reproducing techniques, the stimulable phosphor of the radiation image storage panel is caused to absorb radiation, which carries image information of an object or which has been radiated out from a sample, and thereafter the stimulable phosphor is exposed to an electromagnetic wave (stimulating rays), such as visible light or infrared rays, which causes the stimulable phosphor to produce the fluorescence (i.e., to emit light) in proportion to the amount of energy stored thereon during its exposure to the radiation. The produced fluorescence (i.e., the emitted light) is photoelectrically detected to obtain an electric signal. The electric signal is then processed, and the processed electric signal is utilized for reproducing a visible image of the object or the sample. The radiation image storage panel, from which the electric signal has been obtained, is subjected to an erasing operation for erasing energy remaining on the radiation image storage panel, and the erased radiation image storage panel is utilized again for the image recording. Specifically, the radiation image storage panel is used repeatedly.

The radiation image recording and reproducing techniques have the advantages in that a radiation image containing a large amount of information is capable of being obtained with a markedly lower dose of radiation than in the conventional radiography utilizing a radiation film and an intensifying screen. Also, with the conventional radiography, the radiation film is capable of being used only for one recording operation. However, with the radiation image recording and reproducing techniques, the radiation image storage panel is used repeatedly. Therefore, the radiation image recording and reproducing techniques are advantageous also from the view point of resource protection and economic efficiency.

As described above, the radiation image recording and reproducing techniques are the advantageous image forming techniques. As in the cases of an intensifying screen employed in the conventional radiography, it is desired that the radiation image storage panel utilized for the radiation image recording and reproducing techniques has a high sensitivity and can yield an image of good image quality (with respect to sharpness, graininess, and the like).

Ordinarily, radiation image storage panels comprising stimulable phosphor layers are formed with processes, wherein a coating composition, which comprises a binder and a stimulable phosphor dispersed in the binder, is applied onto a substrate or a protective layer, and the applied coating composition layer is dried. In this manner, the stimulable phosphor layer is overlaid on the substrate or the protective layer. Therefore, a packing density of the stimulable phosphor in the stimulable phosphor layer is low. Accordingly, in order for the sensitivity of the radiation image storage panel with respect to radiation to be enhanced sufficiently, it is necessary that the layer thickness of the stimulable phosphor layer be set at a large value. Also, in the radiation image recording and reproducing techniques, graininess characteristics of the image are determined by local sway of the number of radiation quanta (i.e., a quantum mottle), structural disturbance of the stimulable phosphor layer of the radiation image storage panel (i.e., a structure mottle), and the like. Therefore, in cases where the layer thickness of the stimulable phosphor layer is small, the number of the radiation quanta absorbed by the stimulable phosphor layer becomes small, and the quantum mottle increases. Also, in cases where the layer thickness of the stimulable phosphor layer is small, the structural disturbance is actualized, and the structure mottle increases. As a result, the image quality of the image becomes bad. Accordingly, in order for the sensitivity of the radiation image storage panel with respect to the radiation and the graininess characteristics of the image to be enhanced, it is necessary that the layer thickness of the stimulable phosphor layer be set at a large value.

However, as for sharpness of the image in the radiation image recording and reproducing techniques, there is a tendency for the sharpness to become high as the layer thickness of the stimulable phosphor layer of the radiation image storage panel becomes small. Therefore, in order for the sharpness to be enhanced, it is necessary that the layer thickness of the stimulable phosphor layer be set at a small value.

Specifically, with the conventional radiation image storage panels comprising the stimulable phosphor layers, which are formed from the binder and the stimulable phosphor, the sensitivity of the radiation image storage panel with respect to the radiation and the graininess characteristics of the image have a tendency with respect to the layer thickness of the stimulable phosphor layer, which tendency is exactly reverse to the tendency of the sharpness of the image with respect to the layer thickness of the stimulable phosphor layer. Therefore, actually, the conventional radiation image storage panels are formed at a certain degree of mutual sacrifice of the sensitivity of the radiation image storage panel with respect to the radiation, the graininess characteristics of the image, and the sharpness of the image. With the conventional radiation image storage panels, in cases where the layer thickness of the stimulable phosphor layer is set at a large value, scattering and diffusion of the stimulating rays due to particles of the stimulable phosphor contained in the stimulable phosphor layer occur markedly, and therefore the sharpness of the image becomes markedly low. Accordingly, the conventional radiation image storage panels have the problems in that the radiation image storage panels, which have good characteristics with respect to both the sensitivity and the sharpness, cannot always be obtained.

In order for the aforesaid problems to be solved, a radiation image storage panel comprising a stimulable phosphor layer, which does not contain the binder, has been proposed. With the proposed radiation image storage panel, in which the stimulable phosphor layer does not contain the binder, the packing rate of the stimulable phosphor is capable of being enhanced markedly, and the directivity of the stimulating rays within the stimulable phosphor layer and the directivity of the light emitted by the stimulable phosphor layer are capable of being enhanced to a higher extent than with the conventional radiation image storage panels described above. Therefore, with the proposed radiation image storage panel, in which the stimulable phosphor layer does not contain the binder, the enhancement of the sharpness of the image is capable of being expected, while the sensitivity of the radiation image storage panel with respect to the radiation and the graininess characteristics of the image are being enhanced.

As for the radiation image storage panel comprising the stimulable phosphor layer, which does not contain the binder, there is a strong demand for a radiation image storage panel, with which an image having good image quality with a high sharpness is capable of being obtained, while the sensitivity of the radiation image storage panel with respect to the radiation and the graininess characteristics of the image are being enhanced. From the point of view described above, a radiation image storage panel has been proposed in, for example, U.S. Pat. No.4,769,549, wherein a stimulable phosphor layer comprises a block structure of crystallographically discontinuous, fine pillar-shaped crystals, which form a depression-protrusion pattern composed of rectangular depressions and protrusions arrayed alternately on a surface of a substrate. The proposed radiation image storage panel comprises the stimulable phosphor layer having the optically isolated fine pillar-shaped block structure. Therefore, it is considered that, with the proposed radiation image storage panel, the stimulating rays and the light emitted by the stimulable phosphor layer are not dissipated outwardly from the pillar-shaped blocks, and the sharpness of the image is capable of being enhanced to a certain extent.

The sharpness of the image depends upon the spreading of the stimulating rays and the light, which is emitted by the stimulable phosphor layer, within the radiation image storage panel for the reasons described below. Specifically, the radiation image information having been stored on the radiation image storage panel is picked up on the time series basis. Therefore, it is desirable that all of the light, which is emitted by the radiation image storage panel when the radiation image storage panel is exposed to the stimulating rays at a given instant, is detected, and the detected value is recorded as an output obtained from a certain pixel on the radiation image storage panel, which pixel has been exposed to the stimulating rays at the given instant. However, in cases where the stimulating rays, which have impinged upon the radiation image storage panel, spread due to scattering within the radiation image storage panel, and the like, and stimulate the stimulable phosphor located on the side outward from the pixel, which is exposed to the stimulating rays at the given instant, the output obtained from a region broader than the pixel, which is exposed to the stimulating rays at the given instant, is recorded as the output obtained from the pixel, which is exposed to the stimulating rays at the given instant. Therefore, the sharpness of the image depends upon the spreading of the stimulating rays and the light, which is emitted by the stimulable phosphor layer, within the radiation image storage panel.

With the radiation image storage panel proposed in U.S. Pat. No. 4,769,549, the stimulating rays and the light emitted by the stimulable phosphor layer are not dissipated outwardly from the pillar-shaped blocks, and the sharpness of the image is capable of being kept higher than with the radiation image storage panel which does not have the pillar-shaped block structure. However, as illustrated in FIG. 15, with the proposed radiation image storage panel, pillar-shaped blocks 65, 65, . . . constituting a stimulable phosphor layer 63 formed on a substrate 61 are the pillar-shaped blocks having grown in a depression-protrusion pattern. The pillar-shaped blocks 65, 65, . . . have a mean particle diameter falling within the range of 10 μm to 400 μm. Also, each of the pillar-shaped blocks 65, 65, . . . , i.e. each of the pillar-shaped blocks 65, 65, . . . having the mean particle diameter falling within the range of 10 μm to 400 μm, is constituted of an aggregate of a plurality of pillar-shaped structures 65a, 65a, . . . Therefore, the degree of isolation of the pillar-shaped blocks 65, 65, . . . with respect to one another within each of the pillar-shaped blocks 65, 65, . . . is low. As a result, the dissipation of the stimulating rays and the light emitted by the stimulable phosphor layer 63 occurs within each of the pillar-shaped blocks 65, 65, . . . Therefore, the sharpness of the obtained image cannot be enhanced to an expected extent. Also, the same depression-protrusion pattern as that on the substrate 61 remain on the surface of the stimulable phosphor layer 63, and therefore the image quality (the graininess characteristics) of the obtained image becomes bad.

### SUMMARY OF THE INVENTION

The primary object of the present invention is to provide a radiation image storage panel, which has a high sensitivity with respect to radiation and is capable of yielding an image having good image quality with good graininess characteristics and a high sharpness.

The present invention provides a radiation image storage panel, comprising a substrate and a stimulable phosphor layer overlaid on the substrate,

wherein the substrate has a plurality of protruding regions over an entire surface of the substrate,

the stimulable phosphor layer comprises a plurality of pillar-shaped structures of a stimulable phosphor, which pillar-shaped structures extend in a layer thickness direction of the stimulable phosphor layer, each of the pillar-shaped structures of the stimulable phosphor having been formed with one of the protruding regions of the substrate as a starting point of the pillar-shaped structure and with a vapor phase deposition technique, and

a surface of the stimulable phosphor layer is formed with only the pillar-shaped structures of the stimulable phosphor, which pillar-shaped structures extend respectively from the protruding regions of the substrate.

In the radiation image storage panel in accordance with the present invention, the plurality of the protruding regions formed over the entire surface of the substrate should preferably be located such that four nearest protruding regions or six nearest protruding regions (in the densest cases) are arrayed regularly with respect to one protruding region. Alternatively, the plurality of the protruding regions formed over the entire surface of the substrate may be located in a random pattern, such that the protruding regions are arrayed uniformly on the average. Also, the plurality of the protruding regions formed over the entire surface of the substrate may have one of various shapes such that the protruding regions have their top surfaces parallel with the substrate. For example, the shape of the protruding regions may be selected from a circular cylinder-like shape, a prism-like shape, a truncated circular cone-like shape, a truncated pyramid-like shape, and the like.

The maximum diameter of each of the protruding regions of the substrate, a height of each of the protruding regions of the substrate, and a spacing between adjacent protruding regions of the substrate should preferably be adjusted such that the plurality of the pillar-shaped structures of the stimulable phosphor, which pillar-shaped structures extend in the layer thickness direction of the stimulable phosphor layer, and each of which pillar-shaped structures of the stimulable phosphor is formed with one of the protruding regions of the substrate as the starting point of the pillar-shaped structure and with the vapor phase deposition technique, are formed one by one, and such that the surface of the stimulable phosphor layer is formed with only the pillar-shaped structures of the stimulable phosphor, which pillar-shaped structures extend respectively from the protruding regions of the substrate. The term “maximum diameter of a protruding region of a substrate” as used herein means the maximum diameter of the circular cylinder in cases where the shape of the protruding regions of the substrate is the circular cylinder-like shape, the length of a diagonal line in cases where the shape of the protruding regions of the substrate is the prism-like shape, and the maximum diameter of a surface parallel with the substrate in cases where the shape of the protruding regions of the substrate is the truncated circular cone-like shape or the truncated pyramid-like shape. Specifically, the radiation image storage panel in accordance with the present invention should preferably be modified such that the maximum diameter of each of the protruding regions of the substrate, a height of each of the protruding regions of the substrate, and a spacing between adjacent protruding regions of the substrate fall respectively within the range of 0.2 μm to 40 μm. The radiation image storage panel in accordance with the present invention should more preferably be modified such that the maximum diameter of each of the protruding regions of the substrate, a height of each of the protruding regions of the substrate, and a spacing between adjacent protruding regions of the substrate fall respectively within the range of 0.5 μm to 10 μm. The shape of the protruding regions of the substrate, the maximum diameters of the protruding regions of the substrate, the heights of the protruding regions of the substrate, and the like, should preferably be uniform. However, the shape of the protruding regions of the substrate, the maximum diameters of the protruding regions of the substrate, the heights of the protruding regions of the substrate, and the like, may be nonuniform.

Also, the radiation image storage panel in accordance with the present invention should preferably be modified such that the radiation image storage panel further comprises a reflecting layer formed on the side of the stimulable phosphor layer, which side is opposite to a stimulating ray incidence side of the stimulable phosphor layer.

Further, the radiation image storage panel in accordance with the present invention may be modified such that the substrate is a glass substrate, and the plurality of the protruding regions of the substrate are formed with a wet etching technique.

Furthermore, the radiation image storage panel in accordance with the present invention should preferably be modified such that pitches of the protruding regions of the substrate fall within the range of 3 μm to 10 μm, and sizes of the protruding regions of the substrate fall within the range of 1 μm to 7 μm. In such cases, the radiation image storage panel in accordance with the present invention should more preferably be modified such that heights of the protruding regions of the substrate fall within the range of 1 μm to 5 μm. The pitches of the protruding regions of the substrate and the heights of the protruding regions of the substrate should preferably be equal to predetermined values.

Also, in cases where the substrate is the glass substrate, the radiation image storage panel in accordance with the present invention should preferably be modified such that the glass substrate has an area of at least 0.05m².

With the radiation image storage panel in accordance with the present invention, the substrate has the plurality of the protruding regions over the entire surface of the substrate, and the stimulable phosphor layer is formed on the substrate. The stimulable phosphor layer comprises the plurality of the pillar-shaped structures of the stimulable phosphor, which pillar-shaped structures extend in the layer thickness direction of the stimulable phosphor layer, each of the pillar-shaped structures of the stimulable phosphor having been formed with one of the protruding regions of the substrate as the starting point of the pillar-shaped structure and with the vapor phase deposition technique. Also, the surface of the stimulable phosphor layer is formed with only the pillar-shaped structures of the stimulable phosphor, which pillar-shaped structures extend respectively from the protruding regions of the substrate. Therefore, with the radiation image storage panel in accordance with the present invention, directivity in the layer thickness direction of the stimulable phosphor layer is capable of being imparted to the stimulating rays or the light emitted by the stimulable phosphor layer, and the sharpness of the obtained image is capable of being enhanced markedly.

Specifically, the stimulable phosphor layer comprises the plurality of the pillar-shaped structures of the stimulable phosphor, which pillar-shaped structures extend in the layer thickness direction of the stimulable phosphor layer, each of the pillar-shaped structures of the stimulable phosphor having been formed with one of the protruding regions of the substrate as the starting point of the pillar-shaped structure. Also, the surface of the stimulable phosphor layer is formed with only the pillar-shaped structures of the stimulable phosphor, which pillar-shaped structures extend respectively from the protruding regions of the substrate. Therefore, a definite interface is formed at the boundary between a pillar-shaped structure, which has been formed with one of the protruding regions of the substrate as the starting point of the pillar-shaped structure, and a pillar-shaped structure, which has been formed with an adjacent protruding region of the substrate as the starting point of the pillar-shaped structure. Therefore, the pillar-shaped structures, which stand close to one another, are optically isolated from one another. Accordingly, in the stimulable phosphor layer, cracks are formed in units of the pillar-shaped structures of the stimulable phosphor.

The optically isolated, fine cracks, which have been formed among the pillar-shaped structures of the stimulable phosphor, impart the directivity in the layer thickness direction of the stimulable phosphor layer to the stimulating rays or the light emitted by the stimulable phosphor layer. Specifically, in cases where the stimulating rays are irradiated to the stimulable phosphor layer having the pillar-shaped structures, which are optically isolated from one another, the stimulating rays enter through a cross-section of each of the pillar-shaped structures of the stimulable phosphor on the layer surface of the stimulable phosphor layer and into the stimulable phosphor layer. Also, the stimulating rays travel to the bottom of the pillar-shaped structure through repeated reflection between the inside surfaces of the pillar-shaped structure by the light guiding effects of the pillar-shaped structure without being dissipated outwardly from the pillar-shaped structure. The stimulating rays are thus absorbed at the bottom of the pillar-shaped structure. Alternatively, the stimulating rays are reflected at the bottom of the pillar-shaped structure and emanate from the pillar-shaped structure in the pillar direction of the pillar-shaped structure through repeated reflection between the inside surfaces of the pillar-shaped structure. Also, the pillar-shaped structure is smaller than the size of each of pixels constituting the image. Therefore, the sharpness of the obtained image is capable of being enhanced markedly.

With the radiation image storage panel in accordance with the present invention, wherein the reflecting layer is formed on the side of the stimulable phosphor layer, which side is opposite to the stimulating ray incidence side of the stimulable phosphor layer, the sharpness of the obtained image is capable of being enhanced even further.

With the radiation image storage panel in accordance with the present invention, wherein the substrate is the glass substrate, and the plurality of the protruding regions of the substrate are formed with the wet etching technique, the heat resistance of the entire substrate, including the protruding regions of the substrate, is capable of being kept high. Also, in cases where the area, over which the protruding regions are formed, becomes broad, the protruding regions are capable of being formed accurately such that the definite boundary may be formed between the protruding regions adjacent to each other. Specifically, the glass substrate, on which the plurality of the fine protruding regions made from a glass material having a high heat resistance have been formed accurately over the broad area, is capable of being obtained. Therefore, the stimulable phosphor layer comprising the pillar-shaped structures of the stimulable phosphor, each of which pillar-shaped structures has been formed so as to correspond to one of the protruding regions of the glass substrate, is capable of being formed. Accordingly, the light, which represents the radiation image information with the pixel resolution corresponding to each pillar-shaped structure of the stimulable phosphor having been formed with one of the protruding regions of the glass substrate as the starting point of the pillar-shaped structure, is capable of being emitted from the stimulable phosphor layer. As a result, a radiation image having a large size is capable of being acquired, which the sharpness of the radiation image is being kept high.

With the radiation image storage panel in accordance with the present invention, wherein the pitches of the protruding regions of the substrate fall within the range of 3 μm to 10 μm, and the sizes of the protruding regions of the substrate fall within the range of 1 μm to 7 μm, the pillar-shaped structures of the stimulable phosphor, i.e. the pixels constituting the radiation image, are capable of being formed in accordance with the pitches of the protruding regions of the substrate. Therefore, lowering of the sharpness of the radiation image is capable of being suppressed. Also, with the radiation image storage panel in accordance with the present invention, wherein the heights of the protruding regions of the substrate fall within the range of 1 μm to 5 μm, each of the pillar-shaped structures of the stimulable phosphor is capable of being formed reliably on one of the protruding regions of the substrate.

With the radiation image storage panel in accordance with the present invention, wherein the glass substrate has an area of at least 0.05 m², markedly good effects of accurately forming the heat-resistant protruding regions on the substrate, which effects cannot easily be obtained with the other processing techniques, are capable of being obtained.

### BRIEF DESCRIPTION OF THE DRAWINGS

FIG. 1 is an explanatory sectional view showing a first embodiment of the radiation image storage panel in accordance with the present invention,

FIG. 2 is an explanatory sectional view showing an example of pillar-shaped structures constituting a stimulable phosphor layer of the radiation image storage panel in accordance with the present invention,

FIG. 3 is an explanatory sectional view showing a different example of pillar-shaped structures constituting a stimulable phosphor layer of the radiation image storage panel in accordance with the present invention,

FIG. 4A is an SEM photograph showing a top surface of a radiation image storage panel formed in Example 2,

FIG. 4B is an SEM photograph showing an upper part of a cross-section of the radiation image storage panel formed in Example 2,

FIG. 4C is an SEM photograph showing a lower part of the cross-section of the radiation image storage panel formed in Example 2,

FIG. 5 is an SEM photograph showing an upper part of a cross-section of a radiation image storage panel formed in Comparative Example 3,

FIG. 6 is an explanatory sectional view showing a second embodiment of the radiation image storage panel in accordance with the present invention,

FIG. 7 is a sectional view showing a glass plate material acting as a raw material of a glass substrate,

FIG. 8 is a sectional view showing the glass plate material, on which a positive resist has been applied uniformly,

FIG. 9 is an explanatory sectional view showing how the positive resist is exposed to light via a mask pattern of a photo mask,

FIG. 10 is a sectional view showing how exposed regions of the positive resist are removed with development processing,

FIG. 11 is a sectional view showing how etching processing is performed on the glass plate material, on which the positive resist remains at positions corresponding to the mask regions,

FIG. 12 is a sectional view showing a glass substrate obtained by removing the positive resist remaining on the glass plate material,

FIG. 13 is an electron microscope photograph showing a plurality of fine protruding regions on the glass substrate,

FIG. 14 is an electron microscope photograph showing a stimulable phosphor layer comprising pillar-shaped crystals, which stand close to one another, and

FIG. 15 is an explanatory sectional view showing a conventional radiation image storage panel.

### DESCRIPTION OF THE PREFERRED EMBODIMENTS

The present invention will hereinbelow be described in further detail with reference to the accompanying drawings.

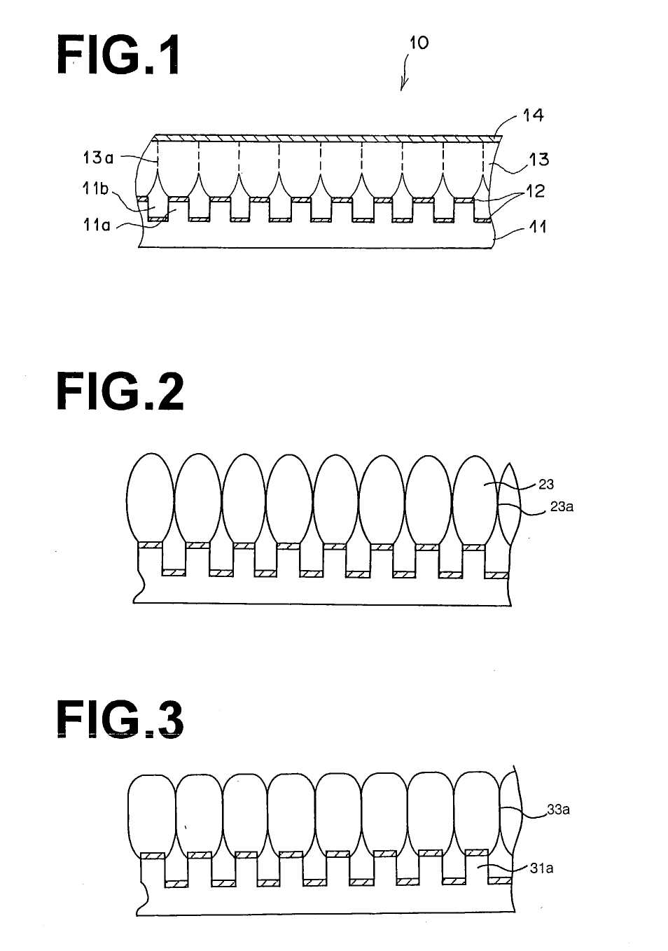

FIG. 1 is an explanatory sectional view showing a first embodiment of the radiation image storage panel in accordance with the present invention. With reference to FIG. 1, a radiation image storage panel 10 comprises a substrate 11, a reflecting layer 12, a stimulable phosphor layer 13, and a protective layer 14, which are overlaid one upon another in this order. Specifically, the substrate 11 has a plurality of protruding regions 11a, 11a, . . . , which are formed over the entire surface of the substrate 11, and the reflecting layer 12 is overlaid on the substrate 11. The stimulable phosphor layer 13 comprises a plurality of pillar-shaped structures 13a, 13a, . . . of a stimulable phosphor, which pillar-shaped structures 13a, 13a, . . . extend in the layer thickness direction of the stimulable phosphor layer 13. Each of the pillar-shaped structures 13a, 13a, . . . of the stimulable phosphor have been formed with one of the protruding regions 11a, 11a, . . . . of the substrate 11, on which protruding regions the reflecting layer 12 has been formed, as the starting point of the pillar-shaped structure 13a and with a vapor phase deposition technique. Also, the protective layer 14 is overlaid on the stimulable phosphor layer 13.

The plurality of the pillar-shaped structures 13a, 13a, . . . of the stimulable phosphor, each of which has been formed with one of the protruding regions 11a, 11a, . . . of the substrate 11 as the starting point of the pillar-shaped structure 13a and with the vapor phase deposition technique, extend in the layer thickness direction of the stimulable phosphor layer 13 and as the structures isolated from one another. Therefore, crystals constituting the pillar-shaped structures 13a, 13a, are isolated from one another, and a crack intervenes between adjacent pillar-shaped structures 13a, 13a. Specifically, the cracks are formed in units of the stimulable phosphor crystal in the stimulable phosphor layer 13 comprising the pillar-shaped structures 13a, 13a, . . . Accordingly, the directivity of the stimulating rays and the light emitted by the stimulable phosphor layer 13 is capable of being enhanced, the lateral spread of the stimulating rays and the light emitted by the stimulable phosphor layer 13 is capable of being suppressed, and the sharpness of the obtained image is capable of being enhanced.

It is considered that, in cases where the pillar-shaped structures 13a, 13a, . . . of the stimulable phosphor are grown respectively from the protruding regions 11a, 11a, . . . of the substrate 11 and with the vapor phase deposition technique, a single crystal of the stimulable phosphor is grown also at depressed regions 11b, 11b, . . . of the substrate 11. However, the areas above the depressed regions 11b, 11b, . . . of the substrate 11 are closed by the single crystal of the stimulable phosphor, which single crystal occurs on the top surfaces of the protruding regions 11a, 11a, . . . of the substrate 11 and is grown in the lateral direction, more quickly than the growth of the single crystal of the stimulable phosphor from the depressed regions 11b, 11b, . . . of the substrate 11. Therefore, the single crystal of the stimulable phosphor growing from the depressed regions 11b, 11b, . . . of the substrate 11 does not reach the surface of the stimulable phosphor layer 13. Accordingly, the surface of the stimulable phosphor layer 13 is constituted of only the pillar-shaped structures 13a, 13a, . . . of the stimulable phosphor having been grown from the protruding regions 11a, 11a, . . . of the substrate 11, and the image quality of the obtained image is not adversely affected by the growth of the single crystal of the stimulable phosphor growing at the depressed regions 11b, 11b, . . . of the substrate 11. Also, one pillar-shaped structure 13a of the stimulable phosphor corresponds to one protruding region 11a of the substrate 11, and therefore the pillar diameter of the pillar-shaped structures 13a, 13a, . . . of the stimulable phosphor is capable of being controlled arbitrarily. Further, the pillar-shaped structures 13a, 13a, . . . of the stimulable phosphor adhere closely to the protruding regions 11a, 11a, . . . of the substrate 11 in one-to-one correspondence relationship, and therefore the adhesion of the stimulable phosphor layer 13 and the substrate 11 to each other is capable of being enhanced.

As illustrated in FIG. 2, the first embodiment of the radiation image storage panel in accordance with the present invention may be modified such that the top area of each of pillar-shaped structures 23a, 23a, . . . constituting a stimulable phosphor layer 23 has a convex shape having a roundness. In cases where the top area of each of the pillar-shaped structures 23a, 23a, . . . constituting the stimulable phosphor layer 23 has the convex shape, the convex shape of the top area of each of the pillar-shaped structures 23a, 23a, . . . exhibits the lens effects, and therefore the efficiency, with which the light emitted by the stimulable phosphor layer 23 is picked up, is capable of being enhanced.

The pillar-shaped structures 13a, 13a, . . . of the stimulable phosphor shown in FIG. 1 and the pillar-shaped structures 23a, 23a, . . . of the stimulable phosphor shown in FIG. 2 are grown from only the top surfaces of the protruding regions 11a, 11a, . . . of the substrate 11. Alternatively, as illustrated in FIG. 3, each of pillar-shaped structures 33a, 33a, . . . of the stimulable phosphor may be grown also from side surfaces of one of protruding regions 31a, 31a, . . . of the substrate so as to surround the corners of the protruding region 31a.

In FIG. 1, the reflecting layer 12 is illustrated such that the reflecting layer 12 is overlaid on only the top surfaces of the protruding regions 11a, 11a, . . . of the substrate 11 and the bottom surfaces of the depressed regions 11b, 11b, of the substrate 11. However, the reflecting layer 12 should preferably be overlaid also on the side surfaces of each of the protruding regions 11a, 11a, . . . of the substrate 11. Also, in FIG. 1, the reflecting layer is formed directly on the surface of the stimulable phosphor layer. Alternatively, such that the adhesion between the reflecting layer and the stimulable phosphor layer may be enhanced, the reflecting layer may be formed on the surface of the stimulable phosphor layer with a prime-coating layer (an under-coating layer) intervening therebetween.

The maximum diameter of each of the protruding regions of the substrate, the height of each of the protruding regions of the substrate, and the spacing between adjacent protruding regions of the substrate should preferably be adjusted such that the plurality of the pillar-shaped structures of the stimulable phosphor, which pillar-shaped structures extend in the layer thickness direction of the stimulable phosphor layer, and each of which pillar-shaped structures of the stimulable phosphor is formed with one of the protruding regions of the substrate as the starting point of the pillar-shaped structure and with the vapor phase deposition technique, are formed one by one, and such that the surface of the stimulable phosphor layer is formed with only the pillar-shaped structures of the stimulable phosphor, which pillar-shaped structures extend respectively from the protruding regions of the substrate. The critical value of the maximum diameter of each of the protruding regions of the substrate varies slightly in accordance with the kind of the stimulable phosphor selected, the kind of the vapor phase deposition technique for forming the stimulable phosphor layer, and conditions of the vapor phase deposition technique. By way of example, in cases where an alkali halide phosphor is subjected to vapor phase deposition with a vacuum evaporation technique, the maximum diameter of each of the protruding regions of the substrate should preferably be smaller than 40 μm.

As the substrate employed in the first embodiment of the radiation image storage panel in accordance with the present invention, various high-molecular weight materials, glass materials, metals, and the like, are capable of being utilized. Preferable examples of the materials for the substrate include plastic film, such as cellulose acetate film, polyester film, polyethylene terephthalate film, polyamide film, polyimide film, triacetate film, or polycarbonate film; glass plates, such as a quartz glass plate, an alkali-free glass plate, a soda-lime glass plate, or a heat-resistant glass plate (a Pyrex (R) plate, or the like) ; metal sheets, such as an aluminum sheet, an iron sheet, a copper sheet, or a chromium sheet; and metal sheets provided with a covering layer of a metal oxide. The thickness of the substrate varies in accordance with the material selected for the substrate, and the like. In the cases of the glass substrate or the metal substrate, the thickness of the substrate should preferably fall within the range of 100 μm to 5 mm, and should more preferably fall within the range of 200 μm to 2 mm.

The protruding dot regions may be formed with one of various known techniques on the substrate. For example, the protruding dot regions of the substrate may be formed by subjecting the substrate itself to an embossing technique or an etching technique. Alternatively, the protruding dot regions of the substrate may be formed with a printing technique, wherein an ink containing a resin, which is capable of fixing to the substrate and being hardened with light, heat, chemical agents, or the like, is printed on the substrate with a gravure printing technique, a silk screen printing technique, and the printed ink is subjected to drying and hardening processes. As another alternative, the protruding dot regions of the substrate may be formed with a photographic etching technique. In the cases of the photographic etching technique, a mask having an insular pattern of regions opaque with respect to light is brought into close contact with a surface of a nylon type of photosensitive resin, ultraviolet light having wavelengths falling within a wavelength range of 250 nm to 400 nm, to which wavelength range the photosensitive resin is sensitive, is irradiated to the photosensitive resin via the mask, and the photosensitive resin is then subjected to development processing. With the development processing, unexposed regions of the photosensitive resin are removed, and exposed regions of the photosensitive resin remain as the protruding regions. In lieu of the mask being brought into close contact with the surface of the photosensitive resin, the irradiation of the ultraviolet light may be performed by use of a lens optical system.

In the first embodiment of the radiation image storage panel in accordance with the present invention, the reflecting layer is formed on the surface of the stimulable phosphor layer, which surface is opposite to the surface of the stimulable phosphor layer on the stimulating ray incidence side. In the first embodiment of the radiation image storage panel in accordance with the present invention, the reflecting layer may have characteristics such that the optical density (i.e., the refractive index) varies at the interface, and the reflecting layer constitute a smooth surface. The reflecting layer should preferably have a mean reflectivity of at least 50% with respect to light having wavelengths falling within the wavelength range of the stimulating rays and/or light having wavelengths falling within the wavelength range of the light emitted by the stimulable phosphor layer, and should more preferably have a mean reflectivity of at least 70% with respect to light having wavelengths falling within the wavelength range of the stimulating rays and/or light having wavelengths falling within the wavelength range of the light emitted by the stimulable phosphor layer. (The reflectivity is capable of being measured with an integrating sphere type of spectro-photometer.) By way of example, the reflecting layer should preferably be a layer having a metallic smooth surface or a ceramic material surface.

The metallic smooth surface may be formed on the surface of the substrate with a vacuum evaporation technique, a sputtering technique, an ion plating technique, a plating technique, or the like. Alternatively, the metallic smooth surface may be formed on the surface of the substrate with a technique, in which a metal foil is laminated with the surface of the substrate. With the vapor phase deposition technique, such as the vacuum evaporation technique, utilizing a metal, the reflecting layer is capable of being formed easily, and the formation of the reflecting layer is not adversely affected by the depression-protrusion form of the surface of the substrate. Therefore, the vapor phase deposition technique, such as the vacuum evaporation technique, utilizing a metal is more preferable. The metal used should preferably be aluminum, silver, chromium, nickel, platinum, rhodium, tin, or the like.

The reflecting layer may be a multi-layer reflecting film (e.g., SiO₂/TiO₂). Alternatively, the reflecting layer may be a combination of a metal film and a protective layer (e.g., SiO₂). As another alternative, the reflecting layer may be a combination of a metal film and a reflection enhancing layer (e.g., MgF₂/CeO₂ or SiO₂/TiO₂).

In cases where a ceramic material sheet or a metal sheet is employed as the reflecting layer, the reflecting layer may also act as the substrate of the radiation image storage panel. In such cases, the protruding dot regions may be formed on the reflecting layer side of the substrate acting also as the reflecting layer, and the stimulable phosphor layer may be formed on the protruding dot regions with the vapor phase deposition technique. In such cases, the protective layer and the reflection enhancing layer may be utilized in combination.

Examples of the stimulable phosphors, which may be employed in the first embodiment of the radiation image storage panel in accordance with the present invention, include the following:

a phosphor represented by the formula SrS:Ce,Sm; SrS:Eu,Sm; ThO₂:Er; or La₂O₂S:Eu,Sm, as described in U.S. Pat. No. 3,859,527,

a phosphor represented by the formula ZnS:Cu,Pb;BaO·xAl₂O₃:Eu wherein 0.8≦x≦10; M¹¹O·xSiO₂: A wherein M^{II}, is Mg, Ca, Sr, Zn, Cd, or Ba, A is Ce, Tb, Eu, Tm, Pb, Tl, Bi, or Mn, and x is a number satisfying 0.5≦x≦2.5; or LnOX:xA wherein Ln is at least one of La, Y, Gd, and Lu, X is at least one of Cl and Br, A is at least one of Ce and Tb, x is a number satisfying 0<x<0.1, as disclosed in U.S. Pat. No. 4,236,078,

a phosphor represented by the formula (Ba₁₋ₓ, M²⁺ₓ)FX:yA wherein M²⁺ is at least one of Mg, Ca, Sr, Zn, and Cd, X is at least one of Cl, Br, and I, A is at least one of Eu, Tb, Ce, Tm, Dy, Pr, Ho, Nd, Yb, and Er, x is a number satisfying 0≦x≦0.6, and y is a number satisfying 0≧y≦0.2, as disclosed in U.S. Pat. No. 4,239,968,

a phosphor represented by the formula xM₃(PO₄)₂·NX₂:yA or M₃(PO₄)₂·yA wherein each of M and N is at least one of Mg, Ca, Sr, Ba, Zn, and Cd, X is at least one of F, Cl, Br, and I, A is at least one of Eu, Tb, Ce, Tm, Dy, Pr, Ho, Nd, Yb, Er, Sb, Tl, Mn, and Sn, x is a number satisfying 0<x≦6, and y is a number satisfying 0≦y≦1; a phosphor represented by the formula nReX₃·mAX′₂:xEu or nReX₃·mAX′₂:xEu,ySm wherein Re is at least one of La, Gd, Y, and Lu, A is at least one of an alkaline earth metal, Ba, Sr, and Ca, each of X and X′ is at least one of F, Cl, and Br, x is a number satisfying 1×10⁻⁴<x<3·10⁻¹, y is a number satisfying 1×10⁻⁴<y<1·10⁻¹, and n and m are numbers satisfying 1×10⁻³<n/m<7·10⁻¹; or an alkali halide phosphor represented by the formula M^{I}X·aM^{II}X′₂·bM^{III}X″₃:cA wherein M^{I} is at least one alkali metal selected from the group consisting of Li, Na, K, Rb, and Cs, M^{II} is at least one bivalent metal selected from the group consisting of Be, Mg, Ca, Sr, Ba, Zn, Cd, Cu, and Ni, M^{III} is at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In, each of X, X′, and X″ is at least one halogen selected from the group consisting of F, Cl, Br, and I, A is at least one metal selected from the group consisting of Eu, Tb, Ce, Tm, Dy, Pr, Ho, Nd, Yb, Er, Gd, Lu, Sm, Y, Tl, Na, Ag, Cu, Bi, and Mg, a is a number satisfying 0≦a<0.5, b is a number satisfying 0<b≦0.5, c is a number satisfying 0<c≦0.2, as described in Japanese Unexamined Patent Publication No. 57(1982)-148285,

a phosphor represented by the formula (Ba₁₋ₓ, M^{II}ₓ)F₂·aBaX₂:yEu, zA wherein M^{II} is at least one of beryllium, magnesium, calcium, strontium, zinc, and cadmium, X is at least one of chlorine, bromine, and iodine, A is at least one of zirconium and scandium, a is a number satisfying 0.5≦a≦1.25, x is a number satisfying 0≦x≦1, y is a number satisfying 10⁻⁶≦y≦2×10⁻¹, and z is a number satisfying 0<z≦10⁻², as described in Japanese Unexamined Patent Publication No. 56(1981)-116777,

a phosphor represented by the formula M^{III}OX:xCe wherein M^{III} is at least one trivalent metal selected from the group consisting of Pr, Nd, Pm, Sm, Eu, Tb, Dy, Ho, Er, Tm, Yb, and Bi, X is either one or both of Cl and Br, and x is a number satisfying 0<x<0.1, as described in Japanese Unexamined Patent Publication No. 58(1983)-69281,

a phosphor represented by the formula Ba₁₋ₓM_{x/2}L_{x/2}FX:yEu²⁺ wherein M is at least one alkaline metal selected from the group consisting of Li, Na, K, Rb, and Cs, L is at least one trivalent metal selected from the group consisting of Sc, Y, La, Ce, Pr, Nd, Pm, Sm, Gd, Tb, Dy, Ho, Er, Tm, Yb, Lu, Al, Ga, In, and Tl, X is at least one halogen selected from the group consisting of Cl, Br, and I, x is a number satisfying 10⁻²≦x≦0.5, and y is a number satisfying 0<y≦0.1, as described in Japanese Unexamined Patent Publication No. 58(1983)-206678, and

a phosphor represented by the formula M^{II}FX·aM^{I}X′·bM′^{II}X″₂·cM^{III}X″′₃·xA:yEu²⁺ wherein M^{II} is at least one alkaline earth metal selected from the group consisting of Ba, Sr, and Ca, M^{I} is at least one alkali metal selected from the group consisting of Li, Na, K, Rb, and Cs, M′^{II} is at least one bivalent metal selected from the group consisting of Be and Mg, M^{III} is at least one trivalent metal selected from the group consisting of Al, Ga, In, and Tl, A is a metal oxide, X is at least one halogen selected from the group consisting of Cl, Br, and I, each of X′, X″, and X″′ is at least one halogen selected from the group consisting of F, Cl, Br, and I, a is a number satisfying 0≦a≦2, b is a number satisfying 0≦b≦10⁻², c is a number satisfying 0≦c≦10², and a+b+c≧10⁻⁶, x is a number satisfying 0<x≦0.5, and y is a number satisfying 0<y≦0.2, as described in Japanese Unexamined Patent Publication No. 59(1984)-75200.

In particular, the alkali halide phosphor is preferable by virtue of the characteristics such that the stimulable phosphor layer is capable of being formed easily with the vacuum evaporation technique, the sputtering technique, or the like. However, the stimulable phosphor utilized in the first embodiment of the radiation image storage panel in accordance with the present invention is not limited to the phosphors enumerated above and maybe selected from a wide variety of phosphors, which are capable of storing energy from radiation when being exposed to the radiation and is capable of emitting the light when being exposed to the stimulating rays after the exposure to the radiation. As the stimulable phosphor contained in the stimulable phosphor layer, the above-enumerated stimulable phosphors may be used alone, or two or more of the above-enumerated stimulable phosphors may be used in combination.

As the vapor phase deposition technique for the stimulable phosphor, one of various known techniques, such as the vacuum evaporation technique, the resistance heating technique, the sputtering technique, and the chemical vapor deposition (CVD) technique, maybe employed. By way of example, how the stimulable phosphor layer is formed with an electron beam vacuum evaporation technique will be described herein below.

The electron beam vacuum evaporation technique has the advantages over the resistance heating technique, and the like, in that the deposition material is capable of being heated in a local area limited manner and is capable of being vaporized instantaneously, and therefore the vaporization rate is capable of being controlled easily. Also, the electron beam vacuum evaporation technique has the advantages in that inconsistency between the composition of the phosphor or the raw material for the phosphor utilized as the deposition material and the composition of the phosphor in the formed stimulable phosphor layer is capable of being suppressed.

In cases where the stimulable phosphor layer is to be formed with a multi-source vacuum evaporation technique (i.e., a co-evaporation technique), at least two deposition materials, i.e. a deposition material containing the nucleus (M^{I}X) constituent of the stimulable phosphor described above and a deposition material containing the activator (A) constituent, are prepared as the deposition materials. The multi-source vacuum evaporation technique has the advantages in that, in cases where the vapor pressure of the nucleus constituent of the phosphor and the vapor pressure of the activator constituent are largely different from each other, each of the deposition rate of the nucleus constituent of the phosphor and the deposition rate of the activator constituent is capable of being controlled. In accordance with the composition of the desired stimulable phosphor, one of the deposition material may be constituted of only the nucleus constituent of the phosphor, and the other deposition material may be constituted of only the activator constituent. Alternatively, one of the deposition material may be constituted of a mixture of the nucleus constituent of the phosphor and an additive constituent, or the like, and the other deposition material may be constituted of a mixture of the activator constituent and an additive constituent, or the like. Also, the number of the deposition materials is not limited to two. For example, two deposition materials described above and at least one deposition material, which contains an additive constituent, or the like, may be utilized.

The nucleus constituent of the phosphor may be a compound itself, which constitutes the nucleus. Alternatively, the nucleus constituent of the phosphor may be a mixture of at least two raw materials, which are capable of forming the nucleus compound through reaction. Also, ordinarily, the activator constituent is a compound containing the activator element. For example, a halide of the activator element is utilized as the activator constituent.

In cases where the activator A is Eu, the molar ratio of the Eu²⁺ in the Eu compound of the activator constituent should preferably be at least 70%. Ordinarily, Eu²⁺ and Eu³⁺ are contained as a mixture in the Eu compound. However, the desired light (or the desired instantaneously emitted light) is emitted from the phosphor containing Eu²⁺ as the activator. Therefore, as described above, the molar ratio of the Eu²⁺ in the Eu compound of the activator constituent should preferably be at least 70%. The Eu compound should preferably be EuBrₓ. In such cases, x should preferably be a number falling within the range of 2.0≦x≦2.3. Also, in such cases, x should more preferably be a number of 2.0. However, in cases where x is set at a number close to 2.0, oxygen is apt to mix in the Eu compound. Therefore, actually, a stable state is obtained in cases where x is a number close to 2.2, and the ratio of Br is thus comparatively high.

From the view point of prevention of bumping, the water content of the deposition material should preferably be at most 0.5% by weight. Dehydration of the deposition material may be performed with a process, wherein the phosphor constituent described above is heated at a temperature falling within the range of 100° C. to 300° C. under reduced pressure. Alternatively, the dehydration of the deposition material may be performed with a process, wherein the phosphor constituent described above is heated at a temperature equal to at least the melting temperature of the phosphor constituent for a time of several minutes to several hours and in an atmosphere free from moisture, such as a nitrogen atmosphere.

The relative density of the deposition material should preferably fall within the range of 80% to 98%, and should more preferably fall within the range of 90% to 96%. If the deposition material is in a powder state with a low relative density, the problems will occur in that the powder flies at the time of the vacuum evaporation process, or in that the powder cannot be vaporized uniformly from the surface of the deposition material, and therefore the film thickness of the deposited film becomes nonuniform. Accordingly, in order for a reliable vapor evaporation process to be achieved, the density of the deposition material should preferably be comparatively high. In order for the relative density to be set within the range described above, ordinarily, the powder is press-molded at a pressure of at least 20 MPa and formed into a tablet shape. Alternatively, the powder may be heated and melted at a temperature equal to at least the melting temperature of the powder and formed into a tablet shape. However, the deposition material need not necessarily take on the form of the tablet shape.

Also, the deposition material, particularly the deposition material containing the nucleus constituent of the phosphor, should preferably have the characteristics, such that the content of alkali metal impurities (i.e., the alkali metals other than the constituent elements of the phosphor) is at most 10 ppm, and such that the content of alkaline earth metal impurities (i.e., the alkaline earth metals other than the constituent elements of the phosphor) is at most 1 ppm. The deposition material having the characteristics described above may be prepared by use of raw materials, in which the contents of the alkali metal impurities and the alkaline earth metal impurities are low. In this manner, a deposited film free from impurities is capable of being formed. Also, with the deposited film free from impurities, the intensity of the emitted light is capable of being enhanced.

The deposition material described above and the substrate are located within a vacuum evaporation apparatus, and the vacuum evaporation apparatus is then evacuated to a degree of vacuum falling within the range of approximately 1×10⁻⁵ Pa to approximately 1×10⁻² Pa. At this time, an inert gas, such as an Ar gas or a Ne gas, may be introduced into the vacuum evaporation apparatus, while the degree of vacuum being kept at a value falling within the range described above. Also, when necessary, a reactive gas, such as O₂ or H₂, may be introduced into the vacuum evaporation apparatus. Further, water vapor pressure in the atmosphere within the vacuum evaporation apparatus should preferably be set at a value of at most 7.0×10⁻³ Pa by the utilization of, for example, a combination of a diffusion pump and a cold trap.

Thereafter, electron beams are produced by two electron guns and are irradiated respectively to the two deposition materials. At this time, the accelerating voltage for the electron beams should preferably be set at a value falling within the range of 1.5 kV and 5.0 kV. With the irradiation of the electron beams, the nucleus constituent of the phosphor, the activator constituent, and the like, acting as the deposition materials are heated, vaporized, and caused to fly. The vaporized deposition materials undergo a reaction in order to form the stimulable phosphor and is deposited on the surface of the substrate. At this time, the vaporization rate of each of the deposition materials is capable of being controlled by the adjustment of the accelerating voltage for each electron beam, or the like. The rate with which the stimulable phosphor is deposited, i.e. the deposition rate, should preferably fall within the range of 0.05 μm/minute to 300 μm/minute. If the deposition rate is lower than 0.05 μm/minute, the productivity of the first embodiment of the radiation image storage panel in accordance with the present invention cannot be kept high. If the deposition rate is higher than 300 μm/minute, control of the deposition rate will become difficult. The irradiation of the electron beams may be performed in a plurality of stages, and two or more deposited films may thereby be formed. Also, when necessary, the substrate may be cooled or heated during the vacuum evaporation process.

After the vacuum evaporation process has been finished, the deposited film having been obtained is subjected to heat treatment (annealing treatment). By way of example, the heat treatment may be performed at a temperature falling within the range of 50° C. to 600° C. and for several hours in a nitrogen atmosphere (in which a small amount of oxygen or hydrogen may be contained).

In cases where a one-source vacuum evaporation technique (a pseudo one-source vacuum evaporation technique) is employed, one deposition material, which contains the nucleus constituent of the phosphor and the activator constituent separated with respect to the direction normal to the vapor stream (i.e., with respect to the direction parallel with the substrate), should preferably be prepared. Also, during the vacuum evaporation process, one electron beam may be utilized. Further, the time (i.e., the residence time), during which the electron beam is irradiated to the nucleus constituent region of the deposition material, and the time (i.e., the residence time), during which the electron beam is irradiated to the activator constituent region of the deposition material, may be controlled. In this manner, a deposited film constituted of the stimulable phosphor having uniform composition is capable of being formed.

Alternatively, a one-source vacuum evaporation technique may be employed, wherein the stimulable phosphor itself is utilized as the deposition material. In such cases, as described above, the stimulable phosphor whose water content has been adjusted at a value of at most 0.5% by weight is utilized as the deposition material. Also, the stimulable phosphor acting as the deposition material should preferably have the characteristics, such that the content of alkali metal impurities is at most 10 ppm, and such that the content of alkaline earth metal impurities is at most 1 ppm.

Further, before the deposited film constituted of the stimulable phosphor described above is formed, a deposited film constituted of only the nucleus of the phosphor may be formed. In such cases, a deposited film having better pillar-shaped structures is capable of being obtained. The additives, such as the activator, contained in the deposited film constituted of the stimulable phosphor diffuse through the deposited film, which is constituted of the nucleus of the phosphor, particularly due to the heating at the time of the vacuum evaporation process and/or the heat treatment performed after the vacuum evaporation process. Therefore, the boundary between the additives and the nucleus of the phosphor is not necessarily definite.

In the manner described above, the stimulable phosphor layer, in which the desired pillar-shaped structures of the alkali metal halide type of stimulable phosphor have been grown in the thickness direction of the stimulable phosphor layer, is obtained.

The stimulable phosphor layer does not contain a binder and is constituted of only the alkali metal halide type of the stimulable phosphor described above. Also, a crack intervenes between adjacent pillar-shaped structures of the stimulable phosphor. The layer thickness of the stimulable phosphor layer varies in accordance with the desired characteristics of the radiation image storage panel, means for performing the vapor phase deposition technique, the conditions under which the vapor phase deposition technique is performed, and the like. However, the layer thickness of the stimulable phosphor layer should preferably fall within the range of 10 μm to 1,000 μm, and should more preferably fall within the range of 20 μm to 800 μm. If the layer thickness of the stimulable phosphor layer is smaller than 10 μm, the radiation absorptivity of the stimulable phosphor layer will become markedly low, and the sensitivity of the stimulable phosphor layer with respect to the radiation will become low. As a result, the graininess characteristics of the obtained image will become bad. Further, in such cases, the stimulable phosphor layer will be apt to become transparent, the spread of the stimulating rays in the lateral direction within the stimulable phosphor layer will increase markedly, and the sharpness of the obtained image will become bad.

In the first embodiment of the radiation image storage panel in accordance with the present invention, the protective layer for physically or chemically protecting the stimulable phosphor layer may be formed on the surface of the stimulable phosphor layer, which surface is opposite to the surface of the stimulable phosphor layer on the side of the reflecting layer. The protective layer may be formed with a process, in which a coating composition for the formation of the protective layer is applied directly onto the stimulable phosphor layer. Alternatively, the protective layer maybe formed with a process, in which a protective layer having been prepared previously is adhered to the stimulable phosphor layer. Examples of the materials for the protective layer include ordinary materials for protective layers, such as cellulose acetate, nitrocellulose, a polymethyl methacrylate, a polyvinyl butyral, a polyvinyl formal, a polycarbonate, a polyester, a polyethylene terephthalate, a polyethylene, a polyvinylidene chloride, and nylon. Further, the protective layer may be constituted of a layer of an inorganic substance, such as SiC, SiO₂, SiN, or Al₂O₃, formed with the vacuum evaporation technique, the sputtering technique, or the like.

Also, the protective layer may contain various additives in a dispersed form. Examples of the additives, which may be contained in the protective layer, include light-scattering fine particles, such as fine particles of magnesium oxide, zinc oxide, titanium dioxide, or alumina; a lubricant, such as perfluoro olefin resin powder, or silicone resin powder; and a crosslinking agent, such as a polyisocyanate. In cases where the protective layer is constituted of a high-molecular substance, ordinarily, the layer thickness of the protective layer should preferably fall within the range of approximately 0.1 μm to approximately 20 μm. In cases where the protective layer is constituted of an inorganic compound, such as glass, ordinarily, the layer thickness of the protective layer should preferably fall within the range of 100 μm to 1,000 μm.

In order for the stain resistance of the protective layer to be enhanced, a fluorine resin coating layer may be formed on the surface of the protective layer. The fluorine resin coating layer may be formed with a process, in which a fluorine resin coating composition containing a fluorine resin dissolved (or dispersed) in an organic solvent is applied onto the surface of the protective layer, and the applied layer of the fluorine resin coating composition is dried. The fluorine resin may be used alone. However, ordinarily, the fluorine resin is used as a mixture of the fluorine resin and a resin having good film forming characteristics. Alternatively, the fluorine resin may be used together with an oligomer having a polysiloxane skeleton or an oligomer having a perfluoro alkyl group. Such that interference nonuniformity may be suppressed, and the image quality of the obtained radiation image may be enhanced, the fluorine resin coating layer may also contain a fine particle filler. Ordinarily, the layer thickness of the fluorine resin coating layer should preferably fall within the range of 0.5 μm to 20 μm. For the formation of the fluorine resin coating layer, when necessary, additive constituents, such as a crosslinking agent, a hardener, and an anti-yellowing agent, may also be utilized. In particular, the addition of the crosslinking agent is advantageous for the enhancement of the durability of the fluorine resin coating layer.

The first embodiment of the radiation image storage panel in accordance with the present invention is capable of being obtained in the manner described above. The constitution of the radiation image storage panel may be modified in various known ways. For example, such that the sharpness of the obtained image may be enhanced, at least one of the layers described above may be colored with a coloring agent, which is capable of absorbing the stimulating rays and does not absorb the light emitted by the stimulable phosphor layer.

The first embodiment of the radiation image storage panel in accordance with the present invention will further be illustrated by the following nonlimitative examples.

### EXAMPLES

### Example 1

[Preparation of CsBr Deposition Material]

Firstly, 75 g of CsBr powder was introduced into a powder molding die (inside diameter: 35 mm) made from zirconia. The CsBr powder was then pressed at a pressure of 50 MPa by use of a powder die press molding machine (Table Press TB-5, supplied by NPA System K. K.) and formed into a tablet (diameter: 35 mm, thickness: 20 mm). At this time, the pressure exerted to the CsBr powder was approximately 40 MPa. Thereafter, the tablet was subjected to vacuum drying treatment at a temperature of 200° C. for two hours by use of a vacuum drying machine. The density of the thus obtained tablet was 3.9 g/cm³, and the water content of the tablet was 0.3% by weight.

[Preparation of EuBrₓ Deposition Material]

Firstly, 25 g of EuBrₓ powder (x=2.2) was introduced into a powder molding die (inside diameter: 25 mm) made from zirconia. The EuBr, powder was then pressed at a pressure of 50 MPa by use of the powder die press molding machine and formed into a tablet (diameter: 25 mm, thickness: 10 mm). At this time, the pressure exerted to the EuBr, powder was approximately 80 MPa. Thereafter, the tablet was subjected to vacuum drying treatment at a temperature of 200° C. for two hours by use of the vacuum drying machine. The density of the thus obtained tablet was 5.1 g/cm³, and the water content of the tablet was 0.5% by weight.

[Formation of Radiation Image Storage Panel]

With a dry etching technique utilizing a fluorine type of reactive gas, a protruding dot pattern was formed on the surface of a glass substrate (thickness: 0.7 mm) acting as a substrate. The protruding dot pattern comprised circular cylinder-shaped protruding regions, each of which had a diameter of 2 μm and a height of 2 μm and which were located at a spacing of 1 μm between adjacent protruding regions. An Al layer having a thickness of 100 nm was then formed as a reflecting layer with an EB vacuum evaporation technique. Also, a MgF₂ layer having a thickness of 100 nm was formed as a reflection enhancing layer on the Al layer. Further, a CeO₂ layer having a thickness of 100 nm was formed on the MgF₂ layer. Thereafter, the glass substrate, on which the reflecting layer had been formed, was located within a vacuum evaporation apparatus, and the EuBrₓ tablet and the CsBr tablet were located at predetermined positions within the vacuum evaporation apparatus. The vacuum evaporation apparatus was then evacuated to a degree of vacuum of 1×10⁻³ Pa. Also, the substrate was heated to a temperature of 300° C. with a heating source constituted of a sheathed heater, which was located on the side of the substrate opposite to the deposition surface of the substrate. Further, electron beams having been produced by electron guns were irradiated respectively to the deposition materials, and a CsBr:Eu stimulable phosphor (layer thickness: 400 μm, area: 10 cm×10 cm) was thus deposited on the deposition surface of the substrate. At this time, the emission currents, of the electron guns were adjusted such that the molar concentration ratio of Eu to Cs in the stimulable phosphor might become equal to 0.003:1. The region within the vacuum evaporation apparatus was returned to the atmospheric pressure in a dry atmosphere, and the substrate was then taken out of the vacuum evaporation apparatus.

Thereafter, the substrate was located within a vacuum drying apparatus, into which a gas was capable of being introduced. The vacuum drying apparatus was then evacuated to a degree of vacuum of approximately 1 Pa by use of a rotary pump, and water, and the like, having been adsorbed to the deposited film was thus removed. Also, in the vacuum drying apparatus, the deposited film was then subjected to heat treatment at a temperature of 200° C. for two hours in a nitrogen gas atmosphere. The substrate was then cooled in a vacuum, and the substrate whose temperature had been lowered sufficiently was taken out from the vacuum drying apparatus. It was confirmed that a stimulable phosphor layer having a structure, in which the pillar-shaped structures of the CsBr:Eu stimulable phosphor stood close to one another and densely, had been formed on the substrate. In this manner, a radiation image storage panel having the stimulable phosphor layer comprising the pillar-shaped structures of the stimulable phosphor, each of which pillar-shaped structures had a diameter of 3 μm and a length of 400 μm and had been formed on one of the circular cylinder-shaped protruding regions of the substrate, was formed.

### Example 2 to Example 7

Radiation image storage panels were formed in the same manner as that in Example 1, except that the shape of each of the protruding regions of the substrate, the diameter of each of the protruding regions of the substrate, the height of each of the protruding regions of the substrate, the spacing between adjacent protruding regions of the substrate, the constitution of the reflecting layer, and the film forming technique were altered as listed in Table 1 below.

### Comparative Example 1

A radiation image storage panel was formed in the same manner as that in Example 1, except that the protruding regions and the reflecting layer were not formed on the substrate.

### Comparative Example 2

A radiation image storage panel was formed in the same manner as that in Example 1, except that the protruding regions were not formed on the substrate.

### Comparative Example 3

A radiation image storage panel was formed in the same manner as that in Example 1, except that the shape of each of the protruding regions of the substrate, the diameter of each of the protruding regions of the substrate, the height of each of the protruding regions of the substrate, the spacing between adjacent protruding regions of the substrate, the constitution of the reflecting layer, and the film forming technique were altered as listed in Table 1 below.

TABLE 1

| | Shape and size of protruding regions | | | | Constitution of reflecting layer(material and thickness) | | | | | |
|---|---|---|---|---|---|---|---|---|---|---|
| | | | | | Film forming | First | Second | Third | Fourth | Fifth |
| | Shape | Diameter | Height | Spacing | technique | layer | layer | layer | layer | layer |
| Example 1 | Circular | 2 μm | 2 μm | 1 μm | EB vacuum | Al | MgF₂ | CeO₂ | | |
| | cylinder | | | | evaporation | 100 nm | 100 nm | 100 nm | | |
| Example 2 | Circular | 5 μm | 5 μm | 2 μm | EB vacuum | Al | MgF₂ | CeO₂ | | |
| | cylinder | | | | evaporation | 100 nm | 100 nm | 100 nm | | |
| Example 3 | Circular | 10 μm | 10 μm | 5 μm | EB vacuum | Al | MgF₂ | CeO₂ | | |
| | cylinder | | | | evaporation | 100 nm | 100 nm | 100 nm | | |
| Example 4 | Circular | 30 μm | 30 μm | 10 μm | EB vacuum | Al | MgF₂ | CeO₂ | | |
| | cylinder | | | | evaporation | 100 nm | 100 nm | 100 nm | | |
| Example 5 | Prism | 5 μm | 5 μm | 2 μm | EB vacuum | Al | MgF₂ | CeO₂ | | |
| | | | | | evaporation | 100 nm | 100 nm | 100 nm | | |
| Example 6 | Circular | 5 μm | 5 μm | 2 μm | Sputtering | Al | SiO₂ | TiO₂ | SiO₂ | TiO₂ |
| | cylinder | | | | | 150 nm | 68 nm | 39 nm | 80 nm | 38 nm |
| Example 7 | Circular | 5 μm | 5 μm | 2 μm | — | None | | | | |
| | cylinder | | | | | | | | | |
| Comp. Ex.1 | None | | | | — | None | | | | |
| Comp. Ex.2 | None | | | | EB vacuum | Al | MgFₛ | CeO₂ | | |
| | | | | | evaporation | 100 nm | 100 nm | 100 nm | | |
| Comp. Ex.3 | Circular | 50 μm | 15 μm | 20 μm | — | None | | | | |
| | cylinder | | | | | | | | | |

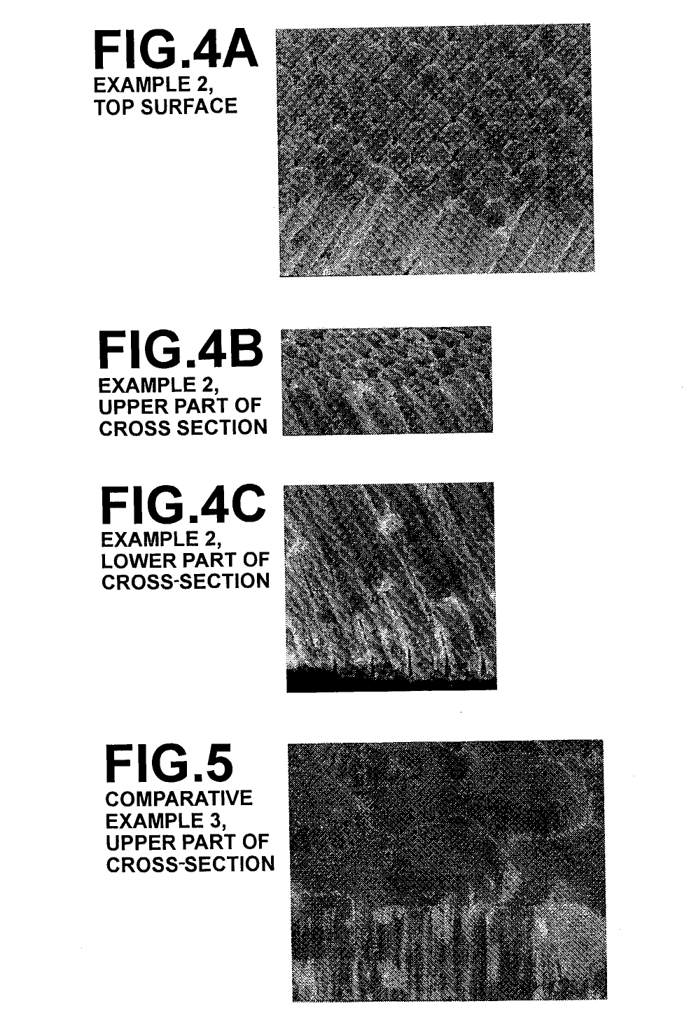

As for each of the radiation image storage panels formed in Examples 1 to 7 and Comparative Examples 1, 2, and 3, the presence or absence of crevices (i.e., irregular crevices occurring at a spacing of several millimeters) in the stimulable phosphor layer was evaluated with visual inspection. Also, adhesion characteristics of the stimulable phosphor layer was evaluated by use of an adhesive tape. Further, pillar shape characteristics were evaluated by use of a scanning electron microscope (JSM-5400, supplied by Nippon Denshi K. K.). Furthermore, the sensitivity of the radiation image storage panel was evaluated in the manner described below. Specifically, X-rays of 1000 mR having been produced at a tube voltage of 80 kVp were irradiated to the radiation image storage panel, and then a semiconductor laser beam having a wavelength of 660nm was irradiated to the radiation image storage panel with an intensity and for a time such that the stimulating ray quantity might be 20 J/m². Also, the light, which was emitted by the radiation image storage panel when the radiation image storage panel was thus exposed to the laser beam, was detected by a photomultiplier via a band-pass filter (B-410). The intensities of electric signals having thus been detected from the aforesaid radiation image storage panels were compared with one another. In this manner, the sensitivity of the radiation image storage panel was evaluated. The sharpness of the image obtained with the radiation image storage panel was evaluated in the manner described below. Specifically, a lead plate was placed on the radiation image storage panel. Also, X-rays of 100 mR having been produced at a tube voltage of 80 kVp were irradiated to the radiation image storage panel, and the lead plate was then removed from the radiation image storage panel. Thereafter, the radiation image storage panel was set in an image read-out apparatus provided with a semiconductor laser capable of producing a laser beam having a wavelength of 660 nm, and an image read-out operation was performed on the radiation image storage panel. Also, an edge profile representing an edge of the lead plate was investigated. The edge profiles having been obtained with the aforesaid radiation image storage panels were compared with one another. In this manner, the sharpness was evaluated. The results listed in Table 2 below were obtained. FIG. 4A is an SEM photograph showing a top surface of the radiation image storage panel formed in Example 2. FIG. 4B is an SEM photograph showing an upper part of a cross-section of the radiation image storage panel formed in Example 2. FIG. 4C is an SEM photograph showing a lower part of the cross-section of the radiation image storage panel formed in Example 2. FIG. 5 is an SEM photograph showing an upper part of a cross-section of the radiation image storage panel formed in Comparative Example 3.

TABLE 2

| | CsBr: Eu phosphor layer | | | | |
|---|---|---|---|---|---|
| | Crevice | Adhesion | Pillar shape characteristics | Sensitivity | Sharpness |
| Example 1 | None | ◯ | Uniform pillar-shaped structures | 100 | ⊚ |
| | | | with a pillar diameter of 3 μm | | |
| Example 2 | None | ◯ | Uniform pillar-shaped structures | 90 | ⊚ |
| | | | with a pillar diameter of 7 μm | | |
| Example 3 | None | ◯ | Uniform pillar-shaped structures | 85 | ◯ |
| | | | with a pillar diameter of 15 μm | | |
| Example 4 | None | ◯ | Uniform pillar-shaped structures | 80 | ◯ |
| | | | with a pillar diameter of 40 μm | | |
| Example 5 | None | ◯ | Uniform pillar-shaped structures | 90 | ⊚ |
| | | | with a pillar diameter of 7 μm | | |
| Example 6 | None | ◯ | Uniform pillar-shaped structures | 95 | ⊚ |
| | | | with a pillar diameter of 7 μm | | |
| Example 7 | None | ◯ | Uniform pillar-shaped structures | 80 | ◯ |
| | | | with a pillar diameter of 7 μm | | |
| Comp. Ex. 1 | Ocurred | X | Nonuniform crystals with pillar | 30 | X |
| | | | diameters of 30 μm to 70 μm | | |
| Comp. Ex. 2 | None | Δ | Nonuniform crystals with pillar | 70 | Δ |
| | | | diameters of 20 μm to 50 μm | | |
| Comp. Ex. 3 | None | Δ | Nonuniform pillar-shaped | 50 | Δ |
| | | | structures with a pillar diameter of | | |
| | | | approximately 5 μm | | |

As clear from Table 2 and the SEM photographs shown in FIGS. 4A, 4B, and 4C, each of the radiation image storage panels formed in Examples 1 to 7 in accordance with the present invention comprised the pillar-shaped structures of the stimulable phosphor, each of which pillar-shaped structures had grown with respect to one of the protruding regions of the substrate. Also, the pillar-shaped structures of the stimulable phosphor were isolated from one another by definite interfaces and had uniform pillar diameter. Further, the stimulable phosphor layer was free from crevices and had good adhesion characteristics. Furthermore, the radiation image storage panels in accordance with the present invention had a high sensitivity and were capable of yielding an image having a markedly high sharpness.

The radiation image storage panel formed in Comparative Example 1, in which the protruding regions and the reflecting layer were not formed on the substrate, had the problems in that crevices occurred in the stimulable phosphor layer, the adhesion characteristics of the stimulable phosphor layer were bad, and the radiation image storage panel had a low sensitivity and was not capable of yielding an image having a high sharpness. The radiation image storage panel of Comparative Example 2 was formed in the same manner as that in Example 1, except that the protruding regions were not formed on the substrate. The radiation image storage panel of Comparative Example 2 had the problems in that the adhesion characteristics of the stimulable phosphor layer were worse than with the radiation image storage panel of Example 1, and the radiation image storage panel had a sensitivity lower than the sensitivity of the radiation image storage panel of Example 1 and was not capable of yielding an image having a high sharpness. The radiation image storage panel of Comparative Example 3 was formed in the same manner as that in Example 7, except that the diameter of each of the protruding regions of the substrate was set at a large value of 50 μm. The radiation image storage panel of Comparative Example 3 had the problems in that, as illustrated in FIG. 5, the stimulable phosphor layer comprised an aggregate of nonuniform pillar-shaped structures of the stimulable phosphor, each of which pillar-shaped structures had a diameter smaller than the diameter of each of the protruding regions of the substrate. Also, the radiation image storage panel of Comparative Example 3 had the problems in that the pattern structure of the same shape as the pattern structure of the surface of the substrate remained on the surface of the stimulable phosphor layer, and the sensitivity of the radiation image storage panel and the sharpness of the image obtained with the radiation image storage panel were lower than with the radiation image storage panel of Example 7.

A second embodiment of the radiation image storage panel in accordance with the present invention will be described hereinbelow.

The size required of the radiation image storage panel varies in accordance with the characteristics of an image recording operation. By way of example, the area of the image recording region required of the radiation image storage panel for a chest image recording operation is 450 mm×450 mm. In order for the radiation image storage panel having the size described above to be formed, it is necessary to utilize a substrate having a large size, on which a plurality of fine protruding regions respectively acting as the starting points of the formation of the pillar-shaped structures of the stimulable phosphor have been formed accurately over a broad area.

However, for example, in cases where a plurality of fine protruding regions (e.g., having a height of 3 μm and being located at pitches of 5 μm) are formed over a broad area (e.g., 450 mm×450 mm) on the substrate with the negative resist technique, the problems occur in that, due to reasons of processing, i.e. due to the limit of the resolution with respect to the processing range, the boundary between protruding regions adjacent to each other becomes indefinite, and each of the pillar-shaped structures of the stimulable phosphor cannot always be formed accurately on one of the protruding regions of the substrate. Therefore, a radiation image storage panel capable of yielding a radiation image having a pixel resolution corresponding to each of the protruding regions of the substrate cannot always be obtained easily. Also, for example, in cases where a plurality of fine protruding regions are formed over a broad area on the substrate with the positive resist technique, the plurality of the fine protruding regions are capable of being formed over the broad area on the substrate, but the problems described below occur. Specifically, the heat resistance of the resist (the photosensitive material) constituting the protruding regions is low, and the protruding regions constituted of the resist are deformed by heat applied at the time of the formation of the pillar-shaped structures of the stimulable phosphor. Therefore, each of the pillar-shaped structures of the stimulable phosphor cannot always be formed accurately on one of the protruding regions of the substrate. As a result, as in the cases of the negative resist technique described above, a radiation image storage panel capable of yielding a radiation image having a pixel resolution corresponding to each of the protruding regions of the substrate cannot always be obtained easily. Accordingly, it is desired that the plurality of the fine protruding regions having a high heat resistance are capable of being formed accurately over a broad area on the substrate, and a radiation image storage panel capable of yielding a radiation image having a large size without the image sharpness becoming low is capable of being formed.

In view of the above circumstances, the inventors conducted extensive research with respect to various processing techniques for forming the protruding regions of the substrate, which protruding regions act respectively as the starting points of the formation of the pillar-shaped structures of the stimulable phosphor constituting the stimulable phosphor layer. As a result, the inventors found a processing technique, with which a plurality of fine protruding regions having a high heat resistance are capable of being processed accurately over a broad area of the substrate. It was found that, in cases where the protruding regions of the substrate are formed with the processing technique described above, the pillar-shaped structures of the stimulable phosphor are capable of being formed accurately, such that each of the pillar-shaped structures correspond to one of the protruding regions having been formed over the broad area on the substrate. The second embodiment of the radiation image storage panel in accordance with the present invention is based on the findings described above.

With the second embodiment of the radiation image storage panel in accordance with the present invention, the substrate is a glass substrate, and the plurality of the protruding regions of the substrate are formed with a wet etching technique. In this manner, the heat resistance of the entire substrate, including the protruding regions of the substrate, is capable of being kept high, and the area over which the protruding regions are formed, is capable of being set to be broad. As a result, the pillar-shaped structures of the stimulable phosphor are capable of being formed accurately such that each of the pillar-shaped structures corresponds to one of the protruding regions having been formed accurately over the broad area on the substrate.

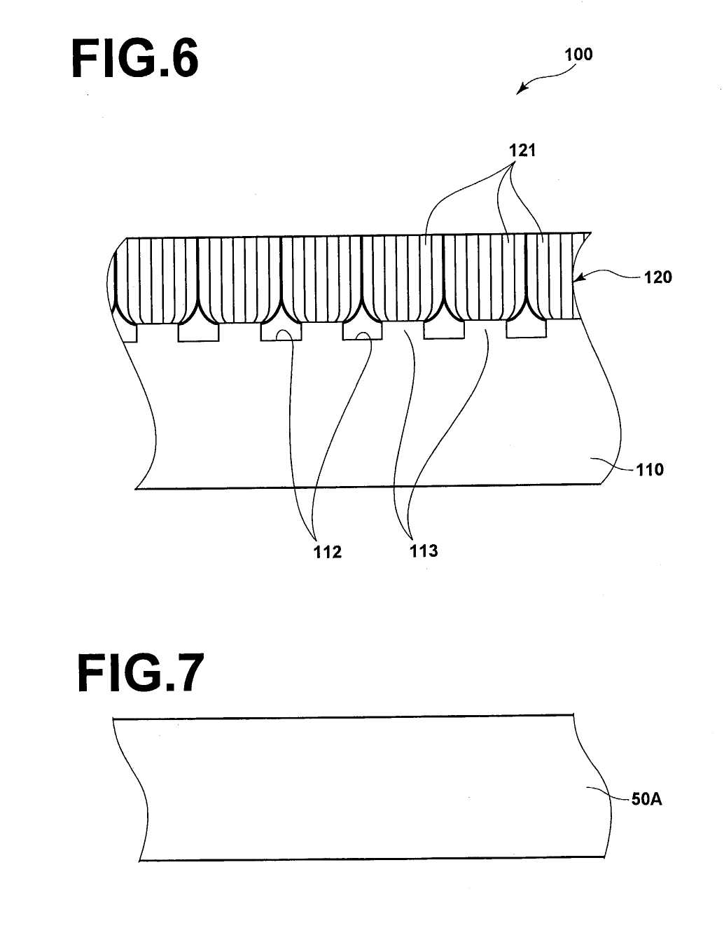

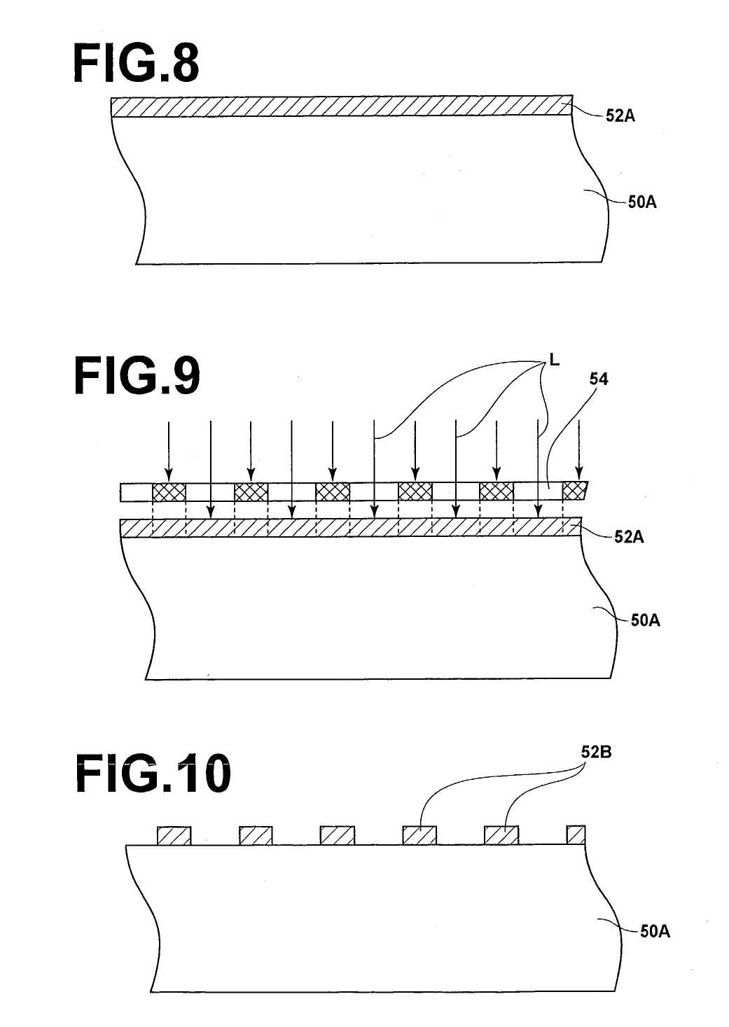

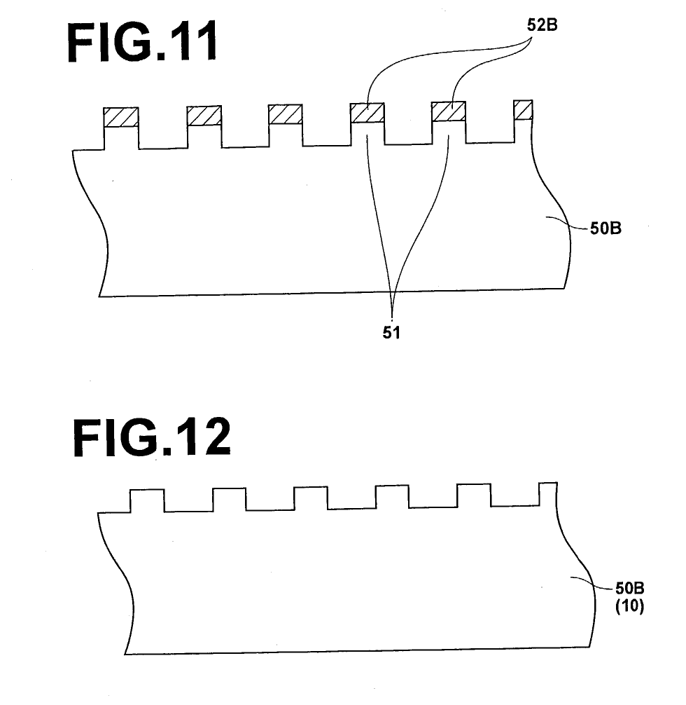

The second embodiment of the radiation image storage panel will be described hereinbelow with reference to the accompanying drawings. FIG. 6 is an explanatory sectional view showing the second embodiment of the radiation image storage panel in accordance with the present invention. FIG. 7 is a sectional view showing a glass plate material acting as a raw material of a glass substrate. FIG. 8 is a sectional view showing the glass plate material, on which a positive resist has been applied uniformly. FIG. 9 is an explanatory sectional view showing how the positive resist is exposed to light via a mask pattern of a photo mask. FIG. 10 is a sectional view showing how exposed regions of the positive resist are removed with development processing. FIG. 11 is a sectional view showing how etching processing is performed on the glass plate material, on which the positive resist remains at positions corresponding to the mask regions. FIG. 12 is a sectional view showing a glass substrate obtained by removing the positive resist remaining on the glass plate material.

With reference to FIG. 6, a radiation image storage panel 100, which is the second embodiment of the radiation image storage panel in accordance with the present invention, comprises a glass substrate 110 and a stimulable phosphor layer 120, which comprises pillar-shaped structures 121, 121, . . . of a stimulable phosphor formed on the glass substrate 110.

A plurality of fine protruding regions 113, 113, . . . have been formed with a wet etching technique on the side of the glass substrate 110, which side stands facing the stimulable phosphor layer 120. The pitches of the protruding regions 113, 113, . . . of the glass substrate 110 fall within the range of 3 μm to 10 μm, and the sizes of the protruding regions 113, 113, . . . of the glass substrate 110 fall within the range of 1 μm to 7 μm. Also, the heights of the protruding regions 113, 113, . . . of the glass substrate 110, i.e. the differences between the levels of depressed regions 112, 112, . . . and the levels of the protruding regions 113, 113, . . . , fall within the range of 1 μm to 5 μm. Further, the glass substrate 110 has an area of at least 0.05 m².

How the second embodiment of the radiation image storage panel in accordance with the present invention is formed will be described hereinbelow.

[1] Formation of Glass Substrate

The glass substrate may be formed with processing, which comprises (1) a glass plate material washing process, (2) a positive resist applying process, (3) a pre-baking process, (4) an exposure process, (5) a developing and rinsing process, (6) a post-baking process, (7) a wet etching process, and (8) a positive resist removing process. The processes will be described hereinbelow.

(1) Glass Plate Material Washing Process

As illustrated in FIG. 7, a glass plate material 50A acting as the raw material for the glass substrate is made from soda-lime glass and has a size of 450 mm (vertical length)×450 mm (horizontal length)×1 mm (thickness). The glass plate material 50A thus has the size such that a chest radiation image is capable of being acquired. After dust and water had been removed from the surface of the glass plate material 50A, the glass plate material 50A was subjected to wet washing (alkali washing) utilizing a washing liquid, which contained an organic solvent, such as acetone or methanol, and several kinds of chemical agent liquids. The glass plate material 50A was then washed with deionized water, and the washing liquid described above was thus removed from the glass plate material 50A. The glass plate material 50A was then dried.

(2) Positive Resist Applying Process

Thereafter, the glass plate material 50A was set on a spin coater and rotated quickly. In this state, a photosensitive material (i.e., a positive resist) (OFPR, supplied by Tokyo Oka Kogyo K. K.) having been dissolved in an organic solvent and to be used for the printing of a mask pattern was applied dropwise onto the glass plate material 50A. In this manner, as illustrated in FIG. 8, a positive resist layer 52A was coated uniformly on the glass plate material 50A.

As the technique for coating the photosensitive material, one of various techniques, such as a spin coating technique, a doctor blade coating technique, a roll coating technique, a knife coating technique, a bar coating technique, a dip coating technique, and a spray coating technique, may be utilized. Also, as the photosensitive material, a positive resist or a negative resist may be utilized in accordance with the purposes of use. A typical positive resist contains a novolak resin and a sensitizing agent. A typical negative resist contains a photo-polymerization initiator and a binder.

(3) Pre-Baking Process

The glass plate material 50A, on which the positive resist layer 52A had been formed, was heated at a temperature of 100° C. for 10 minutes. In this manner, the positive resist layer 52A was adhered closely to the glass plate material 50A.

The pre-baking process is performed in order to vaporize the organic solvent contained in the resist and thereby to adhere the resist closely to the substrate. The conditions under which the pre-baking process is performed vary in accordance with the kind of the resist coated. In an ordinary pre-baking process, heating is performed at a temperature of approximately 100° C. and for a time of several minutes to several tens of minutes.

(4) Exposure Process

As illustrated in FIG. 9, exposure light was irradiated from above a photo mask 54, and the mask pattern of the photo mask 54 was printed on the positive resist layer 52A with light L having passed through the photo mask 54.

As the photo mask 54 for the exposure, a photo mask having a mask pattern, which comprised 5 μm-diameter light blocking regions acting as the mask and arrayed in two-dimensional directions at pitches of 10 μm, was utilized. Examples of ordinary exposure techniques include a contact exposure technique, a proximity exposure technique, and an exposure technique utilizing an image forming system. One of the exposure techniques is selected in accordance with the exposure area, the number of times of use of the photo mask, the size of fine structures, and the like. In this embodiment, the proximity exposure technique was utilized, and the exposure quantity was set at 200 J/cm².

(5) Developing and Rinsing Process

The positive resist layer 52A having been exposure to the light L was subjected to development processing with an alkali developing solution. In this manner, as illustrated in FIG. 10, the exposed regions of the positive resist layer 52A were removed, and positive resist regions 52B, 52B, . . . constituting protruding regions corresponding to the mask pattern described above were obtained. After the development processing, the glass plate material 50A, to which the positive resist regions 52B, 52B, . . . had been adhered closely, was washed with deionized water for one minute.

For the development processing, one of various developing solutions is selected in accordance with the kind of the resist. In cases where the positive resist is utilized, the exposed resist regions are removed with the development processing. In cases where the negative resist is utilized, the unexposed resist regions are removed with the development processing.

(6) Post-Baking Process

Thereafter, the positive resist regions 52B, 52B, having been formed on the glass plate material 50A were heated at a temperature of 200° C. for five minutes. In this manner, the post-baking process was performed. The post-baking process is performed in order to enhance the durability of the positive resist regions 52B, 52B, . . . acting as a mask in the wet etching process described later.

The conditions under which the post-baking process is performed vary in accordance with the kind of the resist. An ordinary post-baking process is performed at a temperature falling within the range of 100° C. to 250° C. and for a time of several minutes to several tens of minutes.

(7) Wet Etching Process

The glass plate material 50A, to which the positive resist regions 52B, 52B, . . . remaining at the regions masked by the photo mask 54 had been adhered closely, was then subjected to the wet etching process utilizing hydrofluoric acid. The wet etching process was performed for one minute. In this manner, as illustrated in FIG. 11, a glass plate material 50B having been subjected to the wet etching process and having a surface, on which protruding regions 51, 51, . . . had been formed, is obtained. Thereafter, the glass plate material 50B was rinsed with deionized water and dried.

The wet etching process is performed in order to etch the regions on the surface of the glass plate material 50A, which regions are other than the regions closely adhered to the positive resist regions 52B, 52B, . . . after the development processing. In cases where the material acting as the substrate is the glass material, hydrofluoric acid is typically utilized as the etching liquid. In order for the etching rate to be controlled, a mixture of hydrofluoric acid and NH₄F, or the like, may be utilized as the etching liquid. The wet etching process may be performed with a technique, in which the chemical agent liquid is introduced into an etching vessel (made from quartz, Teflon (trade name), or the like), and the glass plate material is dipped in the chemical agent liquid and etched. Alternatively, the wet etching process may be performed with a technique, in which the glass plate material is placed on a support base and rotated, and the chemical agent liquid is sprayed to the glass plate material in order to etch the glass plate material.

(8) Positive Resist Removing Process

The glass plate material 50B, which has been subjected to the wet etching process described above and on which the protruding regions 51, 51, . . . had been formed, was dipped in a resist peeling liquid containing an organic solvent, or the like. In this manner, the positive resisting ions 52B, 52B, . . . remaining on the glass plate material 50B were removed. Thereafter, the glass plate material 50B was rinsed with deionized water and dried. In this manner, as illustrated in FIG. 12, a sample of the glass substrate, on which a plurality of fine protruding regions corresponding to the aforesaid mask pattern had been formed such that the 5 μm-diameter protruding regions were arrayed in two-dimensional directions at pitches of 10 μm, was obtained. Specifically, the glass plate material SOB having been obtained as the sample of the glass substrate was utilized as the glass substrate 110 shown in FIG. 6.

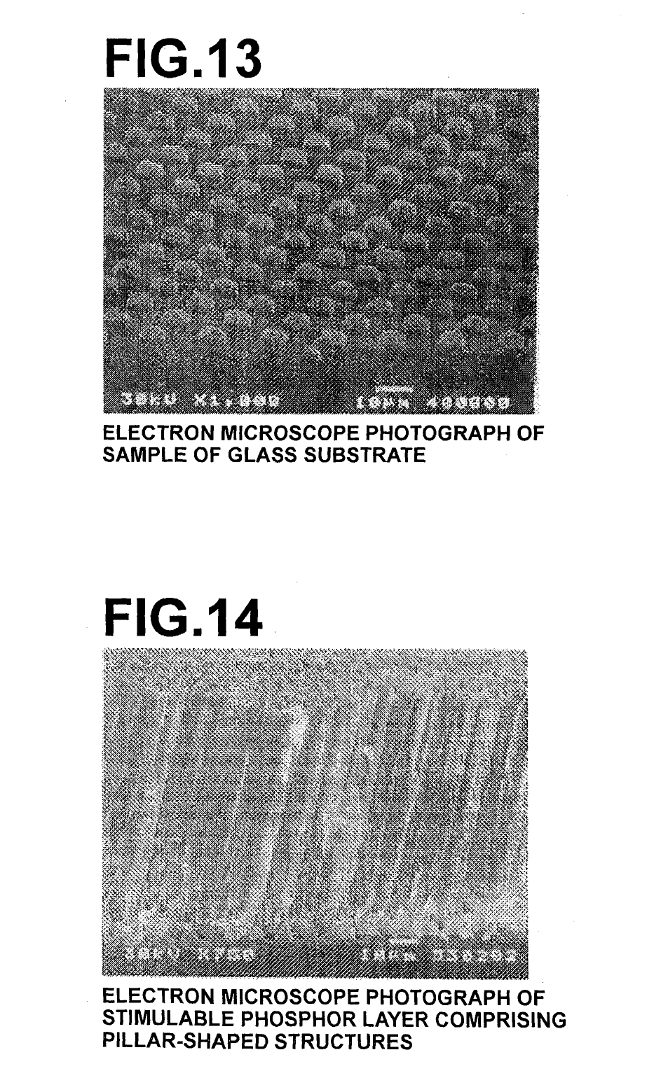

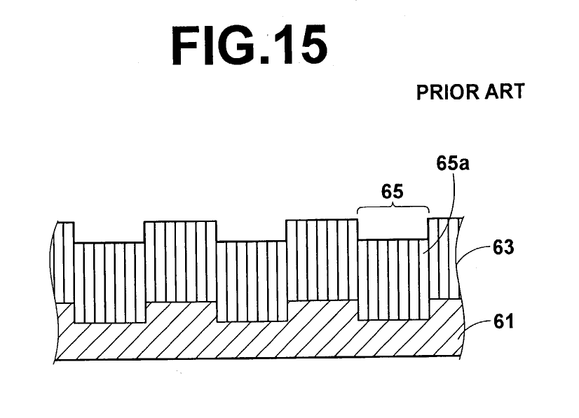

As illustrated in the electron microscope photograph of FIG. 13, it is capable of being found that, in the sample of the glass substrate described above, the protruding regions have been formed accurately on the glass substrate such that the boundary between the protruding regions adjacent to each other is definite.

[2] Formation of Stimulable Phosphor Layer on Glass Substrate

A vacuum evaporation technique utilizing CsBr:Eu was performed on the glass substrate, which had been obtained from the processes described above and on which the plurality of the fine protruding regions had been formed. In this manner, a stimulable phosphor layer comprising the pillar-shaped structures of the stimulable phosphor was formed.

Specifically, firstly, the glass substrate described above was subjected to an alkali washing process.

Thereafter, a synthetic quartz plate having been subjected to deionized water washing and IPA washing was prepared. Also, the surface of the glass substrate, which surface was opposite to the surface provided with the protruding regions, was brought into close contact with the synthetic quartz plate and adhered to the synthetic quartz plate. In this manner, the glass substrate and the synthetic quartz plate were combined into an integral body. Also, the glass substrate and the synthetic quartz plate having been combined into the integral body were fitted to a substrate holder located within a vacuum evaporation chamber of a vacuum evaporation apparatus, such that the protruding regions of the glass substrate stood facing down with respect to the vertical direction.

Thereafter, a CsBr tablet and an EuBr, tablet acting as deposition materials were located at predetermined positions below the glass substrate, which had been located within the vacuum evaporation chamber.

Also, the vacuum evaporation chamber was evacuated to a degree of vacuum of 1×10⁻³ Pa. As an evacuating apparatus, a rotary pump, a mechanical booster, and a turbine molecular air pump were utilized. Alternatively, an ordinarily known pump, such as a cryo pump or diffusion pump, may be utilized as the evacuating apparatus.

The glass substrate located within the vacuum evaporation chamber was heated to a temperature of 300° C. with a heating source constituted of a sheathed heater, and electron beams at an accelerating voltage of 4.0 kV were irradiated to the deposition materials. In this manner, CsBr and EuBr, were co-evaporated to the protruding regions of the glass substrate at a deposition rate of 10 μm/minute, and the pillar-shaped structures of the stimulable phosphor were thus deposited in the vapor phase on the protruding regions of the glass substrate.

As a result, as illustrated in the electron microscope image of FIG. 14, a stimulable phosphor layer (layer thickness: 100 μm) comprising the pillar-shaped structures of the stimulable phosphor, which pillar-shaped structures stood closely to one another in the direction normal to the surface of the glass substrate provided with the protruding regions, and each of which pillar-shaped structures had been formed with one of the protruding regions of the glass substrate as the starting point of the pillar-shaped structure, was formed. Also, the stimulable phosphor layer having been formed in the manner described above was subjected to heat treatment (heating temperature: 200° C.) for improving the light emission characteristics. In this manner, a radiation image storage panel, in which the stimulable phosphor layer comprising the pillar-shaped structures of the stimulable phosphor had been formed on the glass substrate, was obtained. The heating treatment is performed at a temperature falling within the range of 100° C. to 300° C.

[3] Evaluation of Characteristics of Formed Radiation Image Storage Panel

A radiation image was acquired by use of the radiation image storage panel described above, which had the stimulable phosphor layer comprising the CsBr:Eu pillar-shaped structures, and the sharpness of the acquired radiation image was evaluated by use of a CTF chart. As a result, it was found that a radiation image having high sharpness is capable of being acquired with the radiation image storage panel.

Table 3 below shows the results of comparisons between the processing characteristics in cases where the plurality of the fine protruding regions are formed on the substrate with the wet etching technique and the processing characteristics in cases where the plurality of the fine protruding regions are formed on the substrate with other processing techniques.

TABLE 3

| Protruding region | Prosessing | Flexibility of | Heat | Large area | Processing |
|---|---|---|---|---|---|
| processing technique | size | processing shape | resistance | processing | cost |
| Wet etching of glass | ◯ | ◯ | ◯ | ◯ | ◯ |
| plate material | | | | | |
| Positive resist on | ◯ | ◯ | X | ◯ | ◯ |
| glass plate material | | | | | |
| Laser beam processing | ◯ | ◯ | ◯ | X | X |
| of glass plate material | | | | | |
| Negative resist on | X | ◯ | X | ◯ | ◯ |
| glass plate material | | | | | |
| Anodizing | X | X | ◯ | ◯ | ◯ |
| Embossing | X | X | ◯ | ◯ | ◯ |
| Inorganic fine | ◯ | X | ◯ | ◯ | ◯ |
| particle coating | | | | | |

As clear from Table 3, with the negative resist technique, the anodizing technique, the embossing technique, and the inorganic fine particle coating technique, it is difficult to form a plurality of fine protruding regions in desired shapes. With the positive resist technique, the heat resistance of the processed protruding regions is low, and it is difficult to form the stimulable phosphor layer, which comprises the pillar-shaped structures of the stimulable phosphor, on the protruding regions. Also, with the negative resist technique, the accuracy of processing in the broad region becomes low, and it is difficult to form the plurality of fine protruding regions over the entire area of the processing region and with a predetermined accuracy.

The pitches of the protruding regions of the glass substrate need not necessarily fall within the range of 3 μm to 10 μm. Also, the heights of the protruding regions of the glass substrate need not necessarily fall within the range of 1 μm to 5 μm.

Further, the area of the glass substrate need not necessarily be at least 0.05 m². The wet etching technique described above is capable of being applied to glass substrates having various areas.

What is claimed is:

1. A radiation image storage panel, comprising a substrate and a stimulable phosphor layer overlaid on the substrate,
wherein the substrate has a plurality of protruding regions over an entire surface of the substrate,
the stimulable phosphor layer comprises a plurality of pillar-shaped structures of a stimulable phosphor, which pillar-shaped structures extend in a layer thickness direction of the stimulable phosphor layer, each of the pillar-shaped structures of the stimulable phosphor having been formed with one of the protruding regions of the substrate as a starting point of the pillar-shaped structure and with a vapor phase deposition technique, and
a surface of the stimulable phosphor layer is formed with only the pillar-shaped structures of the stimulable phosphor, which pillar-shaped structures extend respectively from the protruding regions of the substrate.

2. A radiation image storage panel as defined in claim 1 wherein the maximum diameter of each of the protruding regions of the substrate, a height of each of the protruding regions of the substrate, and a spacing between adjacent protruding regions of the substrate fall respectively within the range of 0.2 μm to 40 μm.

3. A radiation image storage panel as defined in claim 1 wherein the maximum diameter of each of the protruding regions of the substrate, a height of each of the protruding regions of the substrate, and a spacing between adjacent protruding regions of the substrate fall respectively within the range of 0.5 μm to 10 μm.

4. A radiation image storage panel as defined in claim 1 wherein the radiation image storage panel further comprises a reflecting layer formed on the side of the stimulable phosphor layer, which side is opposite to a stimulating ray incidence side of the stimulable phosphor layer.

5. A radiation image storage panel as defined in claim 2 wherein the radiation image storage panel further comprises a reflecting layer formed on the side of the stimulable phosphor layer, which side is opposite to a stimulating ray incidence side of the stimulable phosphor layer.

6. A radiation image storage panel as defined in claim 3 wherein the radiation image storage panel further comprises a reflecting layer formed on the side of the stimulable phosphor layer, which side is opposite to a stimulating ray incidence side of the stimulable phosphor layer.

7. A radiation image storage panel as defined in claim 1 wherein the substrate is a glass substrate, and the plurality of the protruding regions of the substrate are formed with a wet etching technique.

8. A radiation image storage panel as defined in claim 7 wherein pitches of the protruding regions of the substrate fall within the range of 3 μm to 10 μm, and sizes of the protruding regions of the substrate fall within the range of 1 μm to 7 μm.

9. A radiation image storage panel as defined in claim 7 wherein heights of the protruding regions of the substrate fall within the range of 1 μm to 5 μm.

10. A radiation image storage panel as defined in claim 8 wherein heights of the protruding regions of the substrate fall within the range of 1 μm to 5 μm.

11. A radiation image storage panel as defined in claim 7 wherein the glass substrate has an area of at least 0.05 m².

12. A radiation image storage panel as defined in claim 8 wherein the glass substrate has an area of at least 0.05 m².

13. A radiation image storage panel as defined in claim 9 wherein the glass substrate has an area of at least 0.05 m².
